(19) United States
(12) Patent Application Publication
(10) Pub. No.: US 2010/0065571 A1
(43) Pub. Date: Mar. 18, 2010

(54) Pizza pan with domed center

(76) Inventor: John Olson, Brandon, SD (US)

Correspondence Address: MERCHANT & GOULD PC, P.O. BOX 2903, MINNEAPOLIS, MN, 55402-0903, US

(21) Appl. No.: 12/283,915

(22) Filed: Sep. 16, 2008

(51) Int. Cl. A21B 3/13

(52) U.S. Cl. 220/573.1; 99/447

(57) ABSTRACT

A pizza pan having a base including an annular base portion and a center base portion that meet at a transition region. The center base portion defining a central dome having a convex curvature that extends from the transition region to a center of the pizza pan.

### FIELD OF THE TECHNOLOGY

The present disclosure relates generally to baking pans used in the food industry, and associated methods. More particularly, the present disclosure relates to a pizza pan, and associated methods of making and using a pizza pan.

### BACKGROUND

In the food industry, the quality of a product can be affected by a variety of factors. For example, in the pizza industry both the toppings themselves and the assembly of the toppings can affect the quality of a pizza. For instance, the use of frozen toppings not properly thawed, or wet toppings (e.g., mushrooms, black olives, etc.) not properly drained, can result in a pizza having an underdone center and/or overdone edges. This is due at least in part because moisture and cold naturally migrate to the center of a pizza during the cooking process. Center loading of a pizza can also result in an underdone center and/or overdone edges. Other factors can contribute to pizza quality as well. In general, it is desirable to provide a pan that aids in improving the quality of a pizza product.

### SUMMARY

The present disclosure relates to a pizza pan. The pizza pan has an annular base portion and a center base portion. The annular base portion and the center base portion transition from and into one another at a transition region. The transition region can be a smooth continuous curved surface at the region where the annular base portion and the center base portion meet. The center base portion of the pizza pan generally begins at an elevated center point and can form a smooth curvature that extends to a perimeter where the annular base portion forms an upwardly extending edge. The center base portion has a convex shape that elevates the center region of a pizza during baking use of the pan. In general, the shape of the pizza pan improves the quality of baked pizza products.

A variety of examples of desirable product features or methods are set forth in part in the description that follows, and in part will be apparent from the description, or may be learned by practicing various aspects of the disclosure. The aspects of the disclosure may relate to individual features as well as combinations of features, including combinations of features disclosed in separate embodiments. It is to be understood that both the foregoing general description and the following detailed description are explanatory only, and are not restrictive of the claimed invention.

### BRIEF DESCRIPTION OF THE DRAWINGS

FIG. 1 is a top perspective view of one embodiment of a pizza pan, in accordance with the principles disclosed;

FIG. 2 is a partial, cross-sectional view of the pizza pan of FIG. 1, taken along line 2-2;

FIG. 3 is an enlarged view of a portion of the pizza pan of FIG. 2;

FIG. 4 is a top perspective view of another embodiment of a pizza pan, in accordance with the principles disclosed;

FIG. 5 is a cross-sectional view of the pizza pan of FIG. 4, taken along line 5-5; and

FIG. 6 is an enlarged view of a portion of the pizza pan of FIG. 5.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

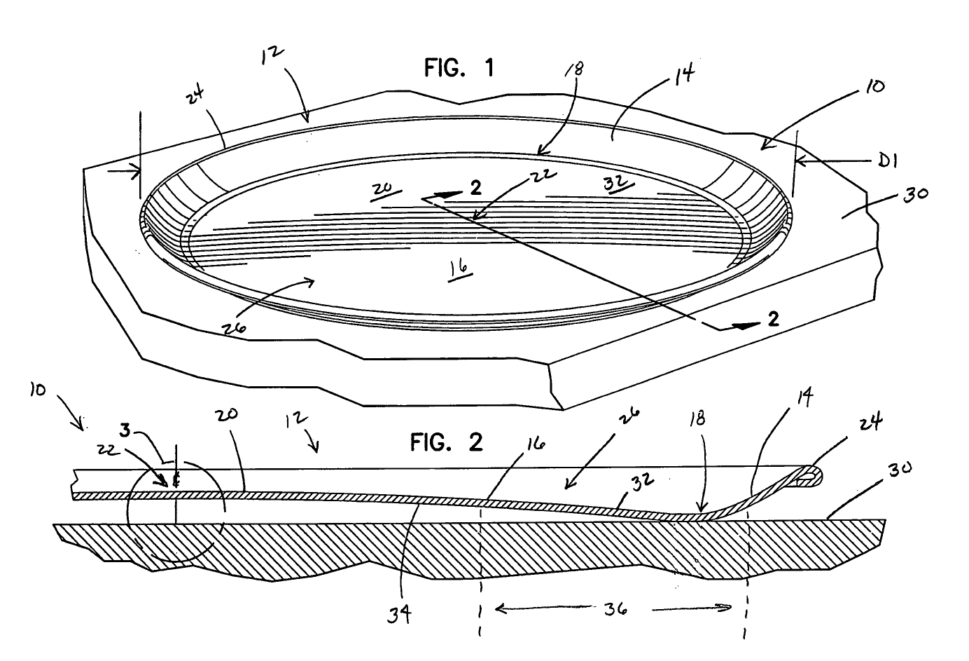

FIG. 1 illustrates one embodiment of a pizza pan 10 in accordance with the principles disclosed. The pizza pan 10 is designed to improve the quality of live dough pizza products. For example, the present pizza pan aids in more evenly cooking a pizza in general, and further aids in reducing the affects of using frozen or wet pizza toppings, and of center loading a pizza.

Referring to FIG. 1, the present pizza pan 10 generally includes a base 12 having an annular base portion 14 and a center base portion 16. The annular base portion 14 and the center base portion 16 are joined or meet at a transition region 18 to form a smooth continuous curved surface that defines a top dough-contacting side 32 of the pizza pan.

The annular base portion 14 defines an outer diameter D1 of the pizza pan 10. The present pizza pan 10 can be used in the preparation and/or cooking of live dough pizza products. What is meant by “live” dough is that the dough has not yet been baked, either partially or fully. The outer diameter D1 of the pizza pan 10 is accordingly greater than the diameter of the live dough pizza product so as to support the entire pizza, including the edges. In the illustrated embodiment, the outer diameter D1 is about 35 to 40 centimeters to accommodate a 14-inch pizza. As can be understood, the base 12 can be constructed to accommodate pizzas of other sizes as well.

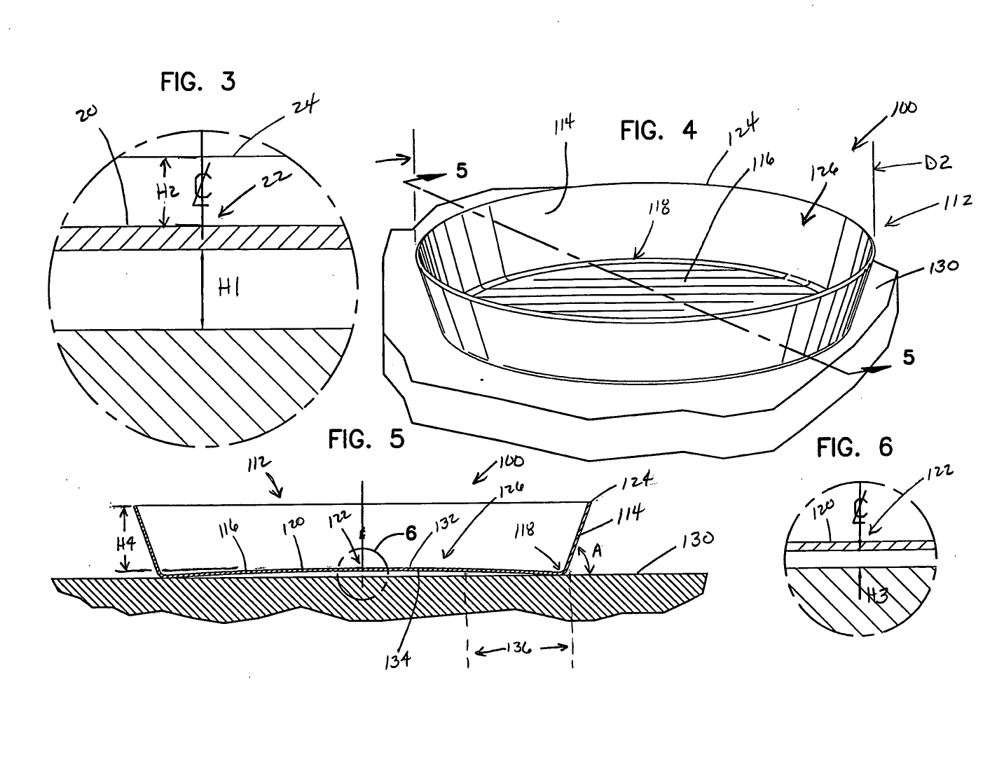

Referring to FIG. 2, the center base portion 16 of the present pizza pan 10 is non-planar, and more specifically, defines a central dome 20 having a generally convex shape. The central dome 20 of the center base portion 16 has a non-stepped convex curvature that extends from the transition region 18 to a center 22 of the pizza pan 10. At the center 22, the pizza pan 10 has a maximum predetermined dome height H1 (FIG. 3) relative to a surface 30 upon which the pizza pan rests. What is meant by maximum “predetermined” dome height is that the maximum dome height is purposefully manufactured into the construction of the pizza pan. The maximum predetermined dome height H1 is between about 1 millimeter and 20 millimeters relative to the surface 30. In the illustrated embodiment, the maximum predetermined dome height H1 is about 6 to 7 millimeters relative to the surface 30.

The annular base portion 14 of the present pizza pan 10 is generally concave in shape. That is, the annular base portion 14 has a non-stepped concave curvature that extends upward from the transition region 18 to an outer peripheral edge or lip 24. The outer peripheral lip 24 extends a height H2 (FIG. 3) above the center 22 of the pizza pan 10, and is designed to prevent toppings of a pizza from falling off the pizza. In one embodiment, the height H2 is between about 1 and 8 centimeters above the center 22 of the pizza pan.

The concave construction of the annular base portion 14 and the convex construction of the center base portion 16 transition into one another to form the smooth continuous curved surface that defines the top dough-contacting side 32 of the pizza pan. Due to these concave and convex constructions, the pizza pan 10 rests only upon the transition region 18 during use. During baking use, in addition to convective heat transfer, the transition region 18 of the pizza pan 10 experiences conductive heat transfer through contact with an oven surface (e.g., 30). The transition region 18 therefore at least partly defines an annular heat zone 36 that is hotter than other regions of the pan. The heat zone 36 is generally located between the peripheral edge 24 of the concave base portion 14 and the center 22 of the convex base portion 16.

In the illustrated embodiment, the base 12 (i.e., the annular concave base portion 14, the center convex base portion 16, and the transition region 18) is made of a steel material. Other materials, such as aluminum, can also be used to construct the base of the pizza pan in accordance with the principles disclosed. In the context of this disclosure, the base 12 of the pan can be a continuous metal piece that is stamped; in the alternative, the base of the pan can be made by joining the center base portion 16 to the annular base portion 14 by conventional joinery. In the illustrated embodiment, the base 12 is a single layer construction 26 of steel material. The base can also be a composite construction having more than one layer of material.

The single layer construction 26 of the base 12 defines the overall structural shape of the pizza pan; in particular, the single layer construction 26 defines the dimensional characteristics of the base 12, such as an average thickness T1 of the base and the outer diameter D1 of the base. In one embodiment, the average thickness of the base is less than about 5 millimeters. The single layer construction 26 in the illustrated embodiment is further a solid construction, as opposed to a construction that is perforated.

The base 12 can also include a non-structural coating layer, such as a non-stick coating layer. In the illustrated embodiment, the non-stick coating layer is provided on at least the top dough-contacting side 32 of the base 12. The non-stick coating layer can be provided on an opposite bottom side 34 (FIG. 2) of the base 12 as well.

The overall construction of the present pizza pan 10 provides improvement in the resulting quality of a baked pizza product. One feature that attributes to the improved quality relates to maintaining placement of toppings on the pizza during the baking process. In particular, the center convex base portion 16 of the pizza pan 10 prevents toppings of a pizza from migrating toward the center of the pizza by elevating the center region of the pizza.

The elevation of the center region of the pizza is a gradual upward sloping toward the center of the pizza that prevents toppings from flowing inward to the center. While the convex curvature of the center base portion is designed to prevent migration of an evenly-distributed normal amount of toppings toward the center, the curvature is not so significant as to cause migration of the toppings toward the edges. Yet, in the event the pizza is center-loaded with toppings, as opposed to being more evenly distributed, the center convex base portion 16 aids in distributing the toppings toward the edges, and toward the hotter heat zone 36 of the pan 10.

The center convex base portion 16 of the disclosed pizza pan 10 further facilitates the dissipation of moisture from a pizza by way of the gradual elevation of the pizza's center region. Moisture tends to dissipate more quickly at the edges of a pizza causing the edges to cook more quickly than the center; the improved dissipation of moisture provided by the present pizza pan lessens the likelihood of overdone pizza edges and underdone pizza centers. The center convex base portion 16 of the disclosed pizza pan 10 also facilitates uniform browning of a pizza by way of the gradual elevation of the center region of the pizza.

Referring now to FIG. 4, another embodiment of a pizza pan 100 constructed in accordance with the principles disclosed is illustrated. The pizza pan 100 is designed to improve the quality of live dough pizza products, such as live-dough deep-dish pizza products.

The pizza pan 100 of FIG. 4 generally includes a base 112 having an annular base portion 114 and a center base portion 116. The annular base portion 114 and the center base portion 116 meet at a transition region 118. The annular base portion 114 defines an outer diameter D2 of the pizza pan 10. In the illustrated embodiment, the outer diameter D2 is about 15 to 20 centimeters to accommodate a 6-inch pizza. As can be understood, the base 112 can be constructed to accommodate pizzas of other sizes as well.

Similar to the previous embodiment and referring to FIG. 5, the center base portion 116 of the pizza pan 100 is non-planar, and more specifically, defines a central dome 120 having a generally convex shape. The central dome 120 of the center base portion 116 has a non-stepped convex curvature that extends from the transition region 118 to a center 122 of the pizza pan 100. At the center 122, the pizza pan 100 has a maximum predetermined dome height H3 (FIG. 6) relative to a surface 130 upon which the pizza pan rests. In the illustrated embodiment, the maximum predetermined dome height H3 is about 2 millimeters relative to the surface 130.

The annular base portion 114 of the pizza pan 100 extends in a generally linear fashion from the transition region to an outer peripheral edge or lip 124. In the illustrated embodiment, the linearly extending annular base portion 114 extends from the transition region 118 at a non-vertical angled orientation (see acute angle A relative to the surface 130). The outer peripheral lip 124 extends a height H4 above the center 122 of the pizza pan 100, and is designed to prevent toppings of a pizza from falling off the pizza.

Still referring to FIG. 5, due to the upwardly extending construction of the annular base portion 114 and the convex construction of the center base portion 116, the pizza pan 100 rests only upon the transition region 118 during use. As previously described with respect to pizza pan 10, the transition region 118 at least partly defines an annular heat zone 136 that is hotter than other regions of the pan. The heat zone 136 is generally located between the peripheral edge 124 of the annular base portion 114 and the center 122 of the convex base portion 116.

The base 112 is made of a single layer construction 126 of a steel material; however, other materials and construction can be employed in accordance with the principles disclosed. The single layer construction 126 of the base 112 defines the overall structural shape of the pizza pan; and in particular, an average thickness T2 of the base (having dimensions as previously described), and the outer diameter D2 of the base. The base 121 can also include a non-structural coating layer, such as a non-stick coating layer, on a top dough-contacting side 132 of the base 112 as well as on an opposite bottom and/or external side 134 of the base 112.

Similar to the previous embodiment, the convex base portion 116 of the pizza pan 100 prevents toppings of a pizza from migrating toward center of the pizza, yet also aids in distributing topping of a center-loaded pizza toward the edges. Also as described above, the convex base portion 116 facilitates the dissipation of moisture and provides for more uniform browning.

The above specification provides a complete description of the present invention. Since many embodiments of the invention can be made without departing from the spirit and scope of the invention, certain aspects of the invention reside in the claims hereinafter appended.

What is claimed is:

1. A pizza pan, comprising:
a) a base including an annular concave base portion and a center convex base portion that meet at a transition region, the annular concave base portion defining an outer diameter of the pizza pan;
b) wherein during baking use, the pizza pan rests only upon the transition region of the base.

2. The pizza pan of claim 1, wherein the center convex base portion has a maximum predetermined dome height at a center of the pizza pan.

3. The pizza pan of claim 2, wherein the maximum predetermined dome height is between about 1 and 20 millimeters relative to a surface upon which the transition region rests during use.

4. The pizza pan of claim 1, wherein the annular concave base portion, the center convex base portion, and the transition region are defined by a single metal layer of material in the form of a continuous curved surface that extends from a center of the pizza pan to the outer diameter.

5. The pizza pan of claim 4, wherein the single metal layer of material has a thickness less than about 5 millimeters.

6. The pizza pan of claim 1, wherein the center convex base portion is defined by a non-stepped curvature extending from the transition region to a center of the pizza pan.

7. The pizza pan of claim 1, wherein the annular concave base portion defines an outer lip that extends a height above the center convex base portion.

8. The pizza pan of claim 7, wherein the height above the center convex base portion is between about 1 and 8 centimeters.

9. The pizza pan of claim 1, Wherein at least a first side of the annular concave base portion and a first side of the center convex base portion include a non-stick coating.

10. The pizza pan of claim 1, wherein the annular concave base portion defines an upwardly curved annular lip that prevents toppings of a pizza from falling off the pizza.

11. The pizza pan of claim 1, wherein during use, the transition region defines a heat zone at which the pizza pan conductively experiences heat transfer from an oven, the heat zone being located between an outer peripheral edge of the annular concave base portion and a center of the center convex base portion.

12. The pizza pan of claim 1, wherein during use, the center convex base portion prevents toppings of a pizza from migrating toward the center of the pizza by elevating the center region of the pizza.

13. The pizza pan of claim 1, wherein during use, the center convex base portion facilitates uniform browning of a pizza by elevating the center region of the pizza.

14. The pizza pan of claim 1, wherein during use, the center convex base portion facilitates the dissipation of moisture from a pizza by elevating the center region of the pizza.

15. A pizza pan, comprising:
a) a base including a center convex base portion and an annular base portion that meet at a transition region, the center convex base portion defining a predetermined dome height, the annular base portion extending upward from the transition region a distance above the dome height; the annular base portion defining an outer diameter of the pizza pan;
b) wherein during baking use, the pizza pan rests only upon the transition region of the base.

16. The pizza pan of claim 15, wherein the annular base portion has a non-stepped concave curvature that extends from the transition region to an outer peripheral edge that defines the outer diameter of the pizza pan.

17. The pizza pan of claim 16, wherein the annular base portion extends a distance above the predetermined dome height of the center convex base portion.

18. The pizza pan of claim 15, wherein the annular base portion is a generally linear construction that extends upward from the transition region.

19. The pizza pan of claim 18, wherein the annular base portion extends a distance above the predetermined dome height of the center convex base portion.
